(19) United States
(12) Patent Application Publication
(10) Pub. No.: US 2007/0027748 A1
(43) Pub. Date: Feb. 1, 2007

(54) Advertisement method using mobile telephone electronic mail

(75) Inventor: Harutaka Saito, Gifu-shi (JP)

Correspondence Address: ADAMS EVANS P.A., 301 SOUTH TRYON STREET, SUITE 2180, TWO WACHOVIA CENTER, CHARLOTTE, NC, 28282-1991, US

(73) Assignee: FIRST DREAM CO., LTD., Gifu-shi, Gifu (JP)

(21) Appl. No.: 10/545,486

(22) PCT Filed: Dec. 25, 2003
(86) PCT No.: PCT/JP03/16700

§ 371 Date: May 2, 2006

(30) Foreign Application Priority Data
Feb. 13, 2003 (JP) 2003-34555

(51) Int. Cl. G07G 1/14; G06Q 30/00

(52) U.S. Cl. 705/14

(57) ABSTRACT

An advertisement method utilizing an electronic mail via mobile phone performed between a headquarters 1, a member store 3, a tenant store 2 as an advertisement sponsor and a registered member 4. The method includes: a step for preparing an advertisement for tenant store 2 registered in the headquarters 1 to be viewed on a mobile phone; a step for collecting a new registered member 4 by the member store 3; a step for collecting a new registered member 4 by the registered member 4; a step for giving and accumulating a point to each of the member stores 3 or the registered members 4 from the headquarters 1 according to the number of viewings of the advertisement of itself and the registered members 4 under itself. According to the accumulated points, the member store 3 and the registered member 4 can purchase a commodity of the tenant store 2.

### TECHNICAL FIELD

The present invention relates to a business model for carrying out commercial advertisement of commodities stored in a tenant store utilizing an electronic mail via mobile phone and for giving a point, which is capable of purchasing a commodity stored in the tenant store, to a viewer of the advertisement.

### BACKGROUND ART

Conventionally, a business model such that, a banner advertisement is made via a communication apparatus such as personal computer, PDA terminal and mobile phone using electronic mail via Internet, and a person who receives the electronic mail to view the banner advertisement is free of charge for the electronic mail (for example, Japanese Unexamined Patent Application Publication No. 2001-273204).

However, in the above-invention, only the electronic mail is carried out free of charge, but none of another privilege is given. Therefore, the number of viewers of the banner advertisement hardly increases, and the ratio of viewers, who receives the electronic mail and transfers the electronic mail to his/her acquaintances, is also small.

Receiver of such electronic mails, in some cases, reluctantly views undesired advertisements. As a result, the number of viewers of advertisements adversely reduces.

The present invention has been proposed in view of the above problems. An object of the present invention is to provide an advertisement method utilizing electronic mail via mobile phone; thereby the number of viewers of banner advertisements via an electronic mail is increased and advertising information can be delivered based on the interest of the viewer.

### DISCLOSURE OF INVENTION

The invention according to claim 1 is an advertisement method utilizing an electronic mail via mobile phone carried out between a headquarters and a member store, a tenant store as an advertisement sponsor and a registered member, comprising the steps of:

preparing an advertisement of the tenant store registered in the headquarters to be viewed via a mobile phone;

collecting a new member to be registered through the member store;

collecting a new member to be registered through the registered member; and

giving and a point to each of the member store and the registered member from the headquarters and accumulating the point in accordance with the number of accesses to the advertisement by the member store itself and registered members in its group, wherein,

the member store and the registered member are entitled to purchase a commodity stored in the tenant store in accordance with the accumulated points.

The invention according to claim 2 is the step of collecting a new member to be registered through the member store or the registered member includes the steps of:

by the member store or the registered member, receiving a transfer mail from the server of the headquarters and transferring the transfer mail to a mail address of an acquaintance of the member store or the registered member;

by the receiver of transfer mail, transmitting a mail to an ID given to the transmitter of the transfer mail;

by the headquarters, transmitting a mail responding to the transmitted mail; and

by the headquarters, giving a new ID to a new registered member who accesses the home page of the member store included in the mail and carrying out registration operation on a screen of the home page and stored in the server of the headquarters.

In the invention according to claim 3, the information to be registered by the receiver on the screen for transferring the mail includes questionnaires to be checked on a category which the receiver is interested in.

In the invention according to claim 4, the server of the headquarters is capable of selecting advertisement information to be delivered based on the registered information of the registered member.

In the invention according to claim 5, the point given to the member store or the registered member is a part of advertisement fee paid by the tenant store to the headquarters converted into the point, the member store and the registered member are entitled to exchange the points with a commodity stored in the tenant store in accordance with the accumulated points.

In the invention according to claim 6, the member store is allowed to select whether or not to make an affiliate agreement with the headquarters, when the affiliate agreement is made, each member store is provided, on the server of the headquarters, with an entry through which the member store itself and the registered members in its group are allowed to enter into the tenant store, every time when the member store itself and the registered members in its group access the entry, a part of advertising fee paid by the tenant store to the headquarters is converted into the point.

### BRIEF DESCRIPTION OF THE DRAWINGS

FIG. 1 is a diagram schematically showing a configuration of a system of an advertisement method utilizing electronic mail via mobile phone in accordance with the present invention;

FIG. 2 is a diagram illustrating the steps for registering to be a registered member.

FIG. 3 is a diagram illustrating the information of registration steps on the screen of a mobile phone; and

FIG. 4 is a diagram illustrating a point system.

### EXPLANATION OF REFERENCE NUMERALS

1 . . . headquarters
2 . . . tenant store
3 . . . member store
4 . . . registered member

### BEST MODE FOR CARRYING OUT THE INVENTION

Now, an embodiment of the present invention will be described below with reference to the drawings. FIG. 1 is a schematic diagram showing a configuration of a system of the advertisement method in accordance with the present invention, which utilizes an electronic mail via mobile phone. As shown in FIG. 1, the system comprises a headquarters 1, a tenant store 2, a member store 3 and a registered member 4.

Begin with, the headquarters 1 collects the tenant store 2, which wants to deliver its advertisement, and the member store 3, which receives the advertisement. And the tenant store 2 prepares a piece of data containing advertisements using characters, photographs with a digital camera or the like, motion pictures etc, and the created data are transmitted to a server of the headquarters 1.

On the other hand, the member store 3 builds a home page for its exclusive use, and the member store 3 is allotted with a URL for the member store only, through which the headquarters 1 administers the home page. Also, the headquarters 1 allots a mail address, which is exclusive use for receiving application from a new member to be registered, to the member store 3.

At a point of time when a certain numbers of tenant stores 2 and member stores 3 have been obtained, the headquarters 1 delivers introducing electronic mail to a mobile phone of the member store 3.

Then, the member stores 3, which have received the introducing electronic mail, transfers the introducing electronic mail to mail addresses of their acquaintances. When an acquaintance, who has received the electronic mail and decides to be a registered member 4, the registration is carried out in the following steps.

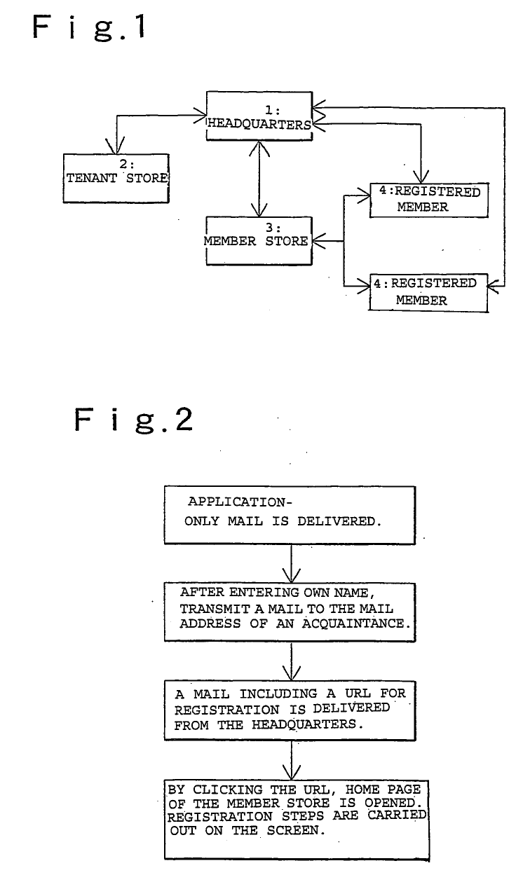

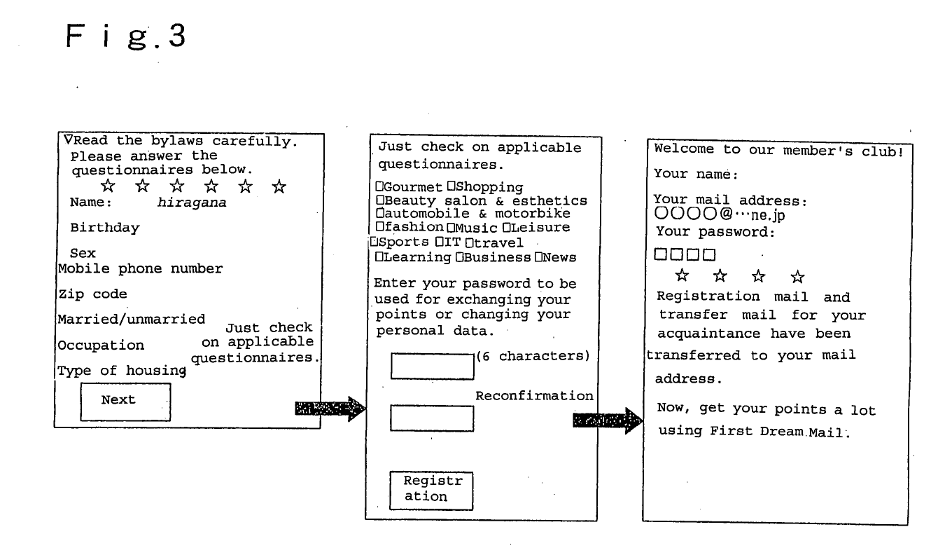

FIG. 2 is a diagram showing the steps of registration to become a registered member. First of all, the acquaintance enters his/her own name with hiragana and transmits the mail to a mail address, which is exclusive use for receiving affiliation application. Then, a mail, in which a URL of the member store that introduced him/her is included, is sent from the headquarters. When the URL is clicked, a home page of the member store is displayed. It is adapted so that the registration steps shown in FIG. 3 are carried out on the home page of the member store.

The registration procedure is extremely simple as described below. That is, after entering his/her name, mobile phone number and the like, he/she answers the questionnaires and enters a password; and then, clicks affiliation button.

When the affiliation button is clicked, the entered information, answers to the questionnaires, the password and the like are transmitted to the server of the headquarters. Then, the headquarters transmits two mails to the newly registered member; i.e., a piece of information of registration confirmation and a mail for transferring to his/her acquaintances. The newly registered member, who has received the two mails, transfers the transferring mail to his/her acquaintance using a known mail address. Thus, by repeating the above steps, the number of the registered members is increased.

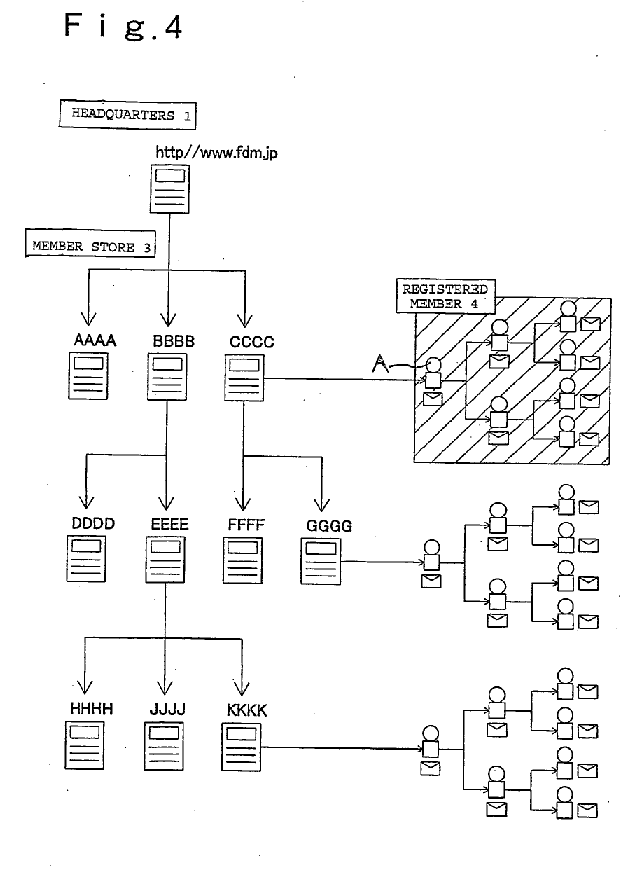

Next, referring to FIG. 4, a point system in an advertisement method utilizing electronic mail in accordance with the present invention will be described below. Here, the wording “point” means a point, which is given to a member store or a registered member every time when the member store or the registered member views the advertisement of the tenant store attached to an electronic mail transmitted from the headquarters. When the points are accumulated, a piece of commodity equivalent to the points can be exchanged at the tenant store.

The point is given not only when the member store or the registered member him/herself views the advertisement. But the point is also given in the following cases. That is, every time when a registered member who is brought in by the member store or a registered member; another registered member, who is brought in by the above registered member; further another registered member brought in by the another registered member, and so on, the access to the advertisement is converted into the point at a predetermined ratio and given thereto. Thus, every access to the advertisement by any one of the registered members in its group (for example, in the case of registered member A in FIG. 4, all of the registered members indicated with slash lines) is converted into the point at a predetermined ratio.

Accordingly, since the given point increases as the number of newly registered members brought by the member store or the registered member, the member store and the registered member are given an incentive to aggressively gather new members to be registered as many as possible.

From the view of the tenant store, the increase of members means the fact that the number of viewers of its advertisement is increased. And when a viewer of the advertisement gets interested in, and visits to the store for shopping, it leads to a sale.

Also, from the view of the headquarters, since the advertising fee is charged on the tenant store according to the number of accesses to the advertisement, the increase of members means the fact that the advertisement income increases. And accordingly, a part of the advertisement income can be imparted as the point to the member store and the registered member.

When a registered member purchases a commodity at the tenant store using the point, the tenant store can receive cash from the headquarters according to the points.

Next, the advertisement of the tenant store, which is delivered to the registered members by the headquarters, will be described. It is adapted so that, when a new member, who wants to be registered, has to answer the questionnaires shown in FIG. 3b on the screen of his/her mobile phone. The answers to the questionnaires are stored in the server of the headquarters. The delivered information of the advertisement for registered members are determined depending on the stored answers.

In the case of a registered member, who has answered to the questionnaires as, for example, he/she is interested in the fashion, but not interested in automobiles or motorbikes, advertisements of clothes, bags and the like stored in the tenant store are transmitted to the registered member. But, the advertisements of new cars, used cars and the like are not transmitted to the registered member. Accordingly, the registered member receives only the advertisements of commodities in the categories that he/she is interested in. And the registered member is free from such disadvantage that he/she receives and reluctantly views such advertisements that he/she is not interested in.

It is conceivable the following case. That is, to the questionnaires at his/her first registration, the registered member answers, about a category of commodities, that he/she is not interested in; but he/she becomes interested therein later. Taking into consideration such case, it is adapted so that the information of the answers registered in the server of the headquarters can be appropriately added and/or changed.

It is needless to say that various embodiments are possible within a range of the spirit of the present invention. In the above-described embodiment, the member store and the registered member use a mobile phone as the means for transmitting and receiving electronic mail. However, the present invention is not limited to the above. It is needless to say that communication apparatus such as personal computer, PDA terminal and the like may be used.

Further, the present invention may be adapted as described below. That is, the member store can select whether the member store makes an affiliate agreement with the headquarters. In the case of a member store, which has made affiliate agreement with the headquarters, an entry, which allows the member store and the registered members in its group to enter into the tenant store, may be provided in the server of the headquarters. And every time when the member store and registered members in its group access to the entry, a part of the advertising fee, which is paid by the tenant store to the headquarters, is converted into the point.

### INDUSTRIAL APPLICABILITY

The invention according to claim 1 is an advertisement method utilizing an electronic mail via mobile phone carried out between a headquarters and a member store, a tenant store as an advertisement sponsor and a registered member, comprising the steps of:

preparing an advertisement of the tenant store registered in the headquarters to be viewed via a mobile phone;

collecting a new member to be registered through the member store;

collecting a new member to be registered through the registered member; and

giving and a point to each of the member store and the registered member from the headquarters and accumulating the point in accordance with the number of accesses to the advertisement by the member store itself and registered members in its group, wherein,

the member store and the registered member are entitled to purchase a commodity stored in the tenant store in accordance with the accumulated points. Compared to the conventional advertisement method utilizing an electronic mail, the number of accesses to the advertisement can be largely increased. Accordingly, it is useful for increasing the sales of advertised the commodities of the tenant store. Also, the advertisement income paid by the tenant store to the headquarters can be increased.

A part of the advertisement income paid to the headquarters can be given to the member store and the registered member as the point. Using the point, the member store and the registered member are entitled to buy a commodity stored in the tenant store. Since an incentive to obtain further new registered members is given, the number of the registered members can be increased.

The invention according to claim 2 is the step of collecting a new member to be registered through the member store or the registered member includes the steps of:

by the member store or the registered member, receiving a transfer mail from the server of the headquarters and transferring the transfer mail to a mail address of an acquaintance of the member store or the registered member;

by the receiver of transfer mail, transmitting a mail to an ID given to the transmitter of the transfer mail;

by the headquarters, transmitting a mail responding to the transmitted mail; and

by the headquarters, giving a new ID to a new registered member who accesses the home page of the member store included in the mail and carrying out registration operation on a screen of the home page and stored in the server of the headquarters. A person, who wants to be a new registered member, is not required to carry out such a troublesome task as filling a registration form, sticking a stamp, posting the same etc for registration. It is convenient because the registration can be carried out on the screen on the mobile phone.

In the invention according to claim 3, the information to be registered by the receiver on the screen for transferring the mail includes questionnaires to be checked on a category which the receiver is interested in. Accordingly, such disadvantage that the registered member reluctantly views undesired advertisement can be eliminated.

In the invention according to claim 4, the server of the headquarters is capable of selecting advertisement information to be delivered based on the registered information of the registered member. Accordingly, it is possible to prevent undesired advertisement from being delivered to the registered members.

In the invention according to claim 5, the point given to the member store or the registered member is a part of advertisement fee paid by the tenant store to the headquarters converted into the point, the member store and the registered member are entitled to exchange the points with a commodity stored in the tenant store in accordance with the accumulated points. Accordingly, unlike the case of refunded money, which is used at unspecified stores for shopping, the point can be exchanged with a commodity equivalent thereto at a tenant store, which provides an advertisement. It is expected that a registered member, who comes to exchange the point, make a shopping another commodity at the tenant store. Accordingly, for the tenant store, such advantage that the advertising effect is increased can be obtained.

In the invention according to claim 6, the member store is allowed to select whether or not to make an affiliate agreement with the headquarters, when the affiliate agreement is made, each member store is provided, on the server of the headquarters, with an entry through which the member store itself and the registered members in its group are allowed to enter into the tenant store, every time when the member store itself and the registered members in its group access the entry, a part of advertising fee paid by the tenant store to the headquarters is converted into the point. Accordingly, it is convenient for the member store to manage the registered members in its group and to check the accumulated points.

1. An advertisement method utilizing an electronic mail via mobile phone carried out between a headquarters and a member store, a tenant store as an advertisement sponsor and a registered member, comprising the steps of:
(a) preparing an advertisement of the tenant store registered in the headquarters to be viewed via a mobile phone;
(b) collecting a new member to be registered through the member store;
(c) collecting a new member to be registered through the registered member; and
(d) giving and a point to each of the member store and the registered member from the headquarters and accumulating the point in accordance with the number of receptions of the advertisement by the member store itself and registered members in its group, wherein,
(i) the member store and the registered member are entitled to purchase a commodity stored in the tenant store in accordance with the accumulated points.

2. The advertisement method utilizing an electronic mail via mobile phone according to claim 1, wherein
(a) the step of collecting a new member to be registered through the member store or the registered member includes the steps of:
(i) by the member store or the registered member, receiving a transfer mail from the server of the headquarters and transferring the transfer mail to a mail address of an acquaintance of the member store or the registered member;
(ii) by the receiver of transfer mail, transmitting a mail to an ID given to the transmitter of the transfer mail;
(iii) by the headquarters, transmitting a mail responding to the transmitted mail; and
(iv) by the headquarters, giving a new ID to a new registered member who accesses the home page of the member store included in the mail and carrying out registration operation on a screen of the home page and stored in the server of the headquarters.

3. The advertisement method utilizing an electronic mail via mobile phone according to claim 2, wherein the information to be registered by the receiver on the screen for transferring the mail includes questionnaires to be checked on a category which the receiver is interested in.

4. The advertisement method utilizing an electronic mail via mobile phone according to claim 3, wherein the server of the headquarters is capable of selecting advertisement information to be delivered based on the registered information of the registered member.

5. The advertisement method utilizing an electronic mail via mobile phone according to claim 4, wherein
(a) the point given to the member store or the registered member is a part of advertisement fee paid by the tenant store to the headquarters converted into the point; and
(b) the member store and the registered member are entitled to exchange the points with a commodity stored in the tenant store in accordance with the accumulated points.

6. The advertisement method utilizing an electronic mail via mobile phone according to claim 5, wherein
(a) the member store is allowed to select whether or not to make an affiliate agreement with the headquarters;
(b) when the affiliate agreement is made, each member store is provided, on the server of the headquarters, with an entry through which the member store itself and the registered members in its group are allowed to enter into the tenant store; and
(c) every time when the member store itself and the registered members in its group access the entry, a part of advertising fee paid by the tenant store to the headquarters is converted into the point.
